(19) United States
(12) Patent Application Publication
(10) Pub. No.: US 2005/0132379 A1
(43) Pub. Date: Jun. 16, 2005

(54) Method, system and software for allocating information handling system resources in response to high availability cluster fail-over events

(75) Inventors: Ananda Chinnaiah Sankaran, Austin, TX (US); Peyman Najafirad, Austin, TX (US); Mark Tibbs, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/733,796

(22) Filed: Dec. 11, 2003

(51) Int. Cl. G06F 9/46

(52) U.S. Cl. 718/105

(57) ABSTRACT

A method, system and software for allocating information handling system resources in response to cluster fail-over events are disclosed. In operation, the method provides for the calculation of a performance ratio between a failing node and a fail-over node and the transformation of an application calendar schedule from the failing node into a new application calendar schedule for the fail-over node. Before implementing the new application calendar schedule for the failing-over application on the fail-over node, the method verifies that the fail-over node includes sufficient resources to process its existing calendar schedule as well as the new application calendar schedule for the failing-over application. A resource negotiation algorithm may be applied to one or more of the calendar schedules to prevent application starvation in the event the fail-over node does not include sufficient resources to process the failing-over application calendar schedule as well as its existing application calendar schedules.

### TECHNICAL FIELD

The present invention relates generally to information handling systems and, more particularly, to maintaining availability of information handling system resources in a high availability clustered environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As employed in the realm of information technology, a high availability cluster may be defined as a group of independent, networked information handling systems that operate and appear to networked clients as if they are a single unit. Cluster networks are generally designed to improve network capacity by, among other things, enabling the information handling systems within a cluster to shift work in an effort to balance the load. By enabling one information handling system to cover for another, a cluster network may enhance stability and minimize or eliminate downtime caused by application or system failure.

Modern information technology applications enable multiple information handling systems to provide high availability of applications and services beyond that a single information handling system may provide. Typically, such applications are hosted on information handling systems that comprise the cluster. Whenever a hardware or software failure occurs on a cluster node, applications are typically moved to one or more surviving cluster nodes in an effort to minimize downtime. A cluster node may be defined as an information handling and computing machine such as a server or a workstation.

When such a fail-over event occurs, a surviving cluster node is generally required to host more applications than it was originally slated to host. As a result, contention for resources of a surviving cluster node will typically occur after a fail-over event. This contention for resources may lead to application starvation because there are no means for the controlled allocation of system resources. This problem may be further exacerbated when fail-over occurs in a heterogeneous cluster configuration. Currently, there are no methods to redistribute information handling system resources to prevent starvation on a surviving cluster node when an additional work load is presented from a failing-over node. In a heterogeneous cluster configuration where the computing resource capabilities of each cluster node are typically different, controlled allocation is further complicated because of resource variations between the different nodes of the cluster.

### SUMMARY OF THE INVENTION

In accordance with teachings of the present disclosure, a method for allocating application processing operations among information handling system cluster resources in response to a fail-over event is provided. In a preferred embodiment, the method preferably begins by identifying a performance ratio between a failing-over cluster node and a fail-over cluster node. The method preferably also performs transforming a first calendar schedule associated with failing-over application processing operations into a second calendar schedule to be associated with failing-over application processing operations on the fail-over cluster node in accordance with a performance ratio. In addition, the method preferably performs implementing the second calendar schedule on the fail-over cluster node such that the fail-over cluster node may effect failing-over application processing operations according to the second calendar schedule.

Also in accordance with teachings of the present disclosure, a system for maintaining resource availability in response to a fail-over event is provided. In a preferred embodiment, the system preferably includes an information handling system cluster having a plurality of nodes and at least one storage device operably coupled to the cluster. The system preferably also includes a program of instructions storable in a memory and executable in a processor of at least one node, the program of instructions operable to identify at least one characteristic of a failing node and at least one characteristic of a fail-over node. The program of instructions is preferably operable to calculate a performance ratio between the failing node and the fail-over node and to transform a processing schedule for at least one failing-over application to a new processing schedule associated with failing-over application processing on the fail-over node in accordance with the performance ratio. The performance ration metric may be applied to an application's existing requirement so as to obtain changed requirements for an application on a fail-over node. In addition, new program instructions is preferably further operable to implement the new processing schedule for the failing-over application on the fail-over node.

Further in accordance with teachings of the present disclosure, software for allocating information handling system resources in a cluster in response to a fail-over event is provided. In a preferred embodiment, the software is embodied in computer readable media and when executed, it is operable to access a knowledge-base containing application resource requirements and available cluster node resources. In addition, the software is preferably operable to calculate a performance ratio between a failing node and a fail-over node and to develop a new processing schedule for a failing-over application on the fail-over node in accordance with the performance ratio. Further, the software is preferably operable to queue the failing-over application for processing on the fail-over node in accordance with the new processing schedule.

In a first aspect, teachings of the present disclosure provide the technical advantage of preventing application starvation resulting from the redistribution of information handling system resources in a heterogeneous cluster configuration.

In another aspect, teachings of the present disclosure provide the technical advantage of verifying the capacity of a fail-over node before implementing failing-over applications on the node.

In a further aspect, teachings of the present disclosure provide the technical advantage of enabling the transformation of application resource requirements across heterogeneous platforms such that the resource requirements of an application on a new platform may be determined after fail-over.

In yet another aspect, teachings of the present disclosure provide the technical advantages of reducing application resource requirements according to the capabilities of a node and continuing to run the applications with the possibility of some performance loss.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating one embodiment of a heterogeneous information handling system cluster configuration incorporating teachings of the present disclosure;

FIG. 2 is a flow diagram illustrating one embodiment of a method for allocating resources in a heterogeneous information handling system cluster configuration incorporating teachings of the present disclosure; and

FIG. 3 is a flow diagram illustrating one embodiment of a method for reallocating resources in a heterogeneous information handling system cluster configuration in response to a fail-over event incorporating teachings of the present disclosure.

### DETAILED DESCRIPTION

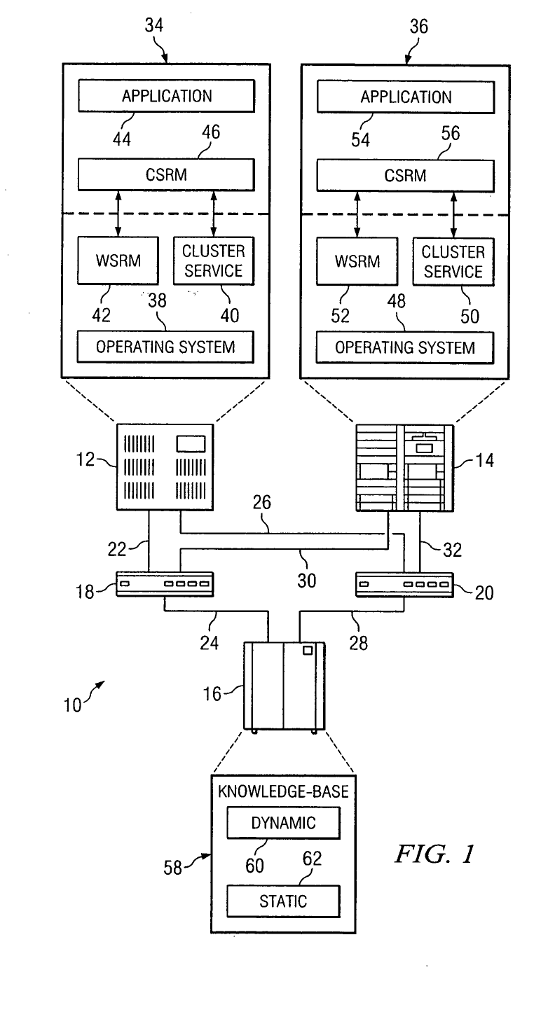

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to FIG. 1, a block diagram illustrating one embodiment of a heterogeneous information handling system cluster configuration operable to reallocate resources in response to a fail-over event according to teachings of the present disclosure is shown. Increasingly complex information handling system cluster configuration implementations are considered within the spirit and scope of the teachings of the present disclosure.

As illustrated in FIG. 1, heterogeneous information handling system cluster configuration 10 preferably includes heterogeneous information handling system servers or nodes 12 and 14. In a heterogeneous cluster configuration such as heterogeneous information handling system cluster configuration 10, the resource requirements of an application executing on one node are generally not applicable to resources available on another node when each node includes or is based on a different platform.

According to teachings of the present disclosure, the platforms on which server nodes 12 and 14 are built may differ in a number of respects. For example, the number of microprocessors possessed by information handling system 12 may differ from the number of microprocessors possessed by information handling system 14. Other aspects in which the platforms of server nodes 12 and 14 may differ include, but are not limited to, memory speed and size, system bus speeds, cache levels and sizes, communication capabilities and redundancies.

In a preferred embodiment, information handling system cluster nodes 12 and 14 may be coupled to shared data storage 16. As illustrated in FIG. 1, information handling system cluster nodes 12 and 14 may be communicatively coupled to shared data storage 16 through one or more switches 18 and 20.

In an effort to increase the availability of shared data storage 16, information handling system cluster node 12 may be coupled thereto via communication links 22 and 24 from information handling system cluster node 12 to switch 18 and from switch 18 to shared data storage 16, respectively. In addition, information handling system cluster node 12 may be coupled to shared data storage 16 via communication links 26 and 28 from information handling system cluster node 12 to switch 20 and from switch 20 to shared data storage 16, respectively. Likewise, information handling system cluster node 14 may be coupled to shared data storage 16 via communication links 30 and 24 from information handling system cluster node 14 to switch 18 and from switch 18 to shared data storage system 16, respectively. Further, a redundant path between information handling system cluster node 14 and shared data storage 16 may be implemented along communication links 32 and 28 from information handling system cluster node 14 to switch 20 and from switch 20 to shared data storage 16, respectively. Other embodiments of connecting information handling system cluster nodes 12 and 14 to shared data storage 16 are considered within the spirit and scope of teachings of the present disclosure.

In a cluster deployment, information handling system cluster nodes 12 and 14 preferably support the execution of one or more server cluster applications. Examples of server cluster applications that may be hosted on information handling system cluster nodes 12 and 14 include, but are not limited to, Microsoft SQL (structured query language) server, exchange server, internet information services (IIS) server, as well as file and print services. Preferably, applications hosted on information handling system cluster nodes 12 and 14 are cluster aware.

Indicated at 34 and 36 are representations of cluster applications and node applications preferably executing on information handling system cluster nodes 12 and 14, respectively. As indicated at 34, information handling system cluster node 12 preferably includes executing thereon, operating system 38, cluster service 40, such as Microsoft Cluster Services (MSCS), system resource manager 42, such as Windows System Resource Manager (WSRM), clustered application 44 and a cluster system resource manager (CSRM) 46. Similarly, as indicated at 36, information handling system cluster node 14 preferably includes executing thereon operating system 48, cluster service 50, system resource manager 52, clustered application 36 and cluster system resource manager 56. In a typical implementation, clustered applications 44 and 54 differ. However, in alternate implementations, clustered applications 44 and 54 may be similar applications operating in accordance with their respective platforms.

As indicated generally at 58, teachings of the present disclosure preferably provide for the inclusion of a knowledge-base in a shared data storage area of shared data storage device 16. According to teachings of the present disclosure, knowledge-base 58 preferably includes dynamic data region 60 and static data region 62.

In one embodiment, knowledge-base 58 may include dynamic data portion 60 data referencing an application-to-node map indicating the cluster node associated with each cluster aware application preferably executing on information handling system cluster configuration 10, one or more calendar schedules of processing operations for cluster aware applications preferably included in information handling system cluster configuration 10, as well as other data. Data preferably included in static data portion 62 of knowledge-base 58 includes, but is not limited to, platform characteristics of information handling system cluster nodes 12 and 14 and preferred resource requirements for cluster aware applications preferably executing on information handling system cluster configuration 10. Data in addition to or in lieu of the data mentioned above may also be included in knowledge-base 58 on shared data storage device 16, according to teachings of the present disclosure.

According to teachings of the present disclosure, a knowledge-base data driven management layer represented by CSRM 46 and 56 is preferably included and interfaces between system resource manager 42 and cluster service 40 with clustered application 44 or 54, for example. In such an embodiment, CSRM 46 and 56 preferably address the issue of resource contention after a fail-over event in information handling system cluster configuration 10 as well as other cluster-based issues.

In an actual fail-over policy, identification of an information handling system node to which an application preferably fails over is typically statically set during clustered configuration. In addition, finer control over cluster aware applications and resource allocation may be effected using a calendar schedule tool generally accessible from WSRM 42 and 52, for example. According to teachings of the present disclosure, CSRM 46 and 56 may leverage calendar schedule capabilities of WSRM 42 and 52 to specify resource allocation policies in the event of a fail-over. Calendar schedule functionality generally aids in applying different resource policies to cluster aware applications at different points in time because of load variations.

According to teachings of the present disclosure, a solution to the resource contention issue after fail-over includes building a knowledge-base operable to aid CSRM 46 and 56 make resource allocation decisions. In a heterogeneous cluster configuration, the resource requirements of a cluster aware application on one information handling system cluster node may not be applicable on another node, especially if the nodes include different platforms. As taught by teachings of the present disclosure, CSRM 46 and 56 preferably enable the transformation of application resource requirements across platforms such that after a fail-over event, the resource requirements of a cluster application on a new platform may be determined. CSRM 46 and 56 is preferably operable to normalize performance behavior for the targeted fail-over node base on a linear equation of configuration differences and information contained in knowledge-base 58.

In operation, cluster service 40 and/or 50 are preferably operable to notify CSRM 46 and/or 56 when a cluster node has failed and when an application needs to fail over to a designated fail-over node. Upon consulting knowledge-base 58, CSRM 46 and/or 56 preferably transforms one or more application requirements of the failing-over application based on characteristics of the node from which it is failing over and creates allocation policies on the new or fail-over node in association with WSRM 42 and/or 52. Such an implementation generally prevents starvation of cluster applications on the fail-over node and generally ensures application processing fairness.

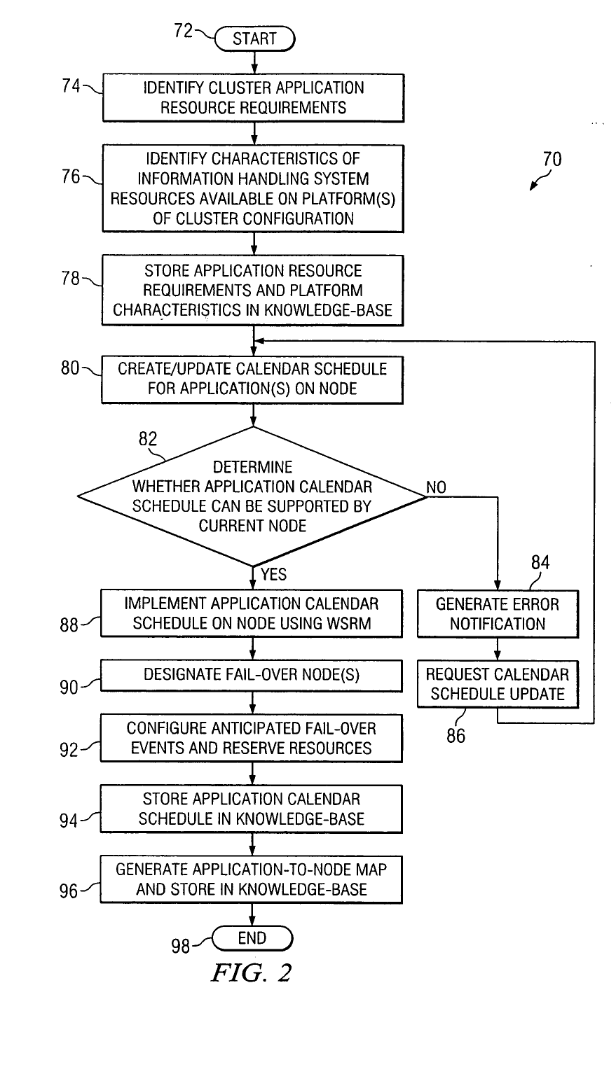

Referring now to FIG. 2, a flow diagram illustrating one embodiment of a method for allocating resources in an information handling system cluster configuration is shown generally at 70. In one aspect, method 70 preferably provides for the acquisition of numerous aspects of information handling system cluster configuration information. In another aspect, method 70 preferably provides for the leveraging of the information handling system cluster configuration information into an effective cluster configuration implementation. In addition, method 70 may advance numerous other aspects of teachings of the present disclosure.

After beginning at 72, method 70 preferably proceeds to 74 where cluster aware application resource requirements are preferably identified. At 74, the resource requirements for cluster applications may address myriad data processing operational aspects. For example, aspects of data processing operation that may be gathered at 74 include, but are not limited to, an application's required or preferred frequency of operation, required or preferred processor usage, required or preferred memory allocation, required or preferred virtual memory allocation, required or preferred cache utilization and required or preferred communication bandwidth.

Additional information gathering performed in method 70 may occur at 76. At 76, one or more characteristics concerning information handling system resources available on the plurality of platforms included in a given information handling cluster configuration are preferably identified and gathered. For example, regarding cluster node 12, the number of processors, amount of cache contained at various levels of the processors, amount of memory available, and communications capabilities as well as other aspects of information handling system cluster node processing capability may be gathered. In addition, the same or similar information may be gathered regarding information handling system cluster node 14, as well as any additional nodes included in information handling system cluster configuration 10.

In a heterogeneous information handling system cluster configuration, such as information handling system cluster configuration 10, characteristics regarding platforms on which the member cluster nodes are based will be different. As such, the identification of characteristics regarding information handling system resources available on the various node platforms available in the cluster configuration are preferably gathered with respect to each node individually.

Following the gathering and identification of cluster application resource requirements at 74 and the characterization of one or more node platforms available in the associated information handling cluster configuration at 76, method 70 preferably proceeds to 78. At 78, the information or data gathered at 74 and 76 may be stored in a knowledge-base, such as knowledge-base 58. In one embodiment, information regarding cluster application resource requirements and the characterization of the platforms available in the information handling system cluster configuration may be stored in static data portion 62 of knowledge-base 58, for example.

Following the preservation of cluster application resource requirements and cluster node platform characteristics in a knowledge-base preferably associated with a shared static data storage device, such as knowledge-base 58 in shared data storage 16, method 70 preferably proceeds to 80. At 80, a calendar schedule for one or more cluster aware application on each node is preferably created or updated. In general, a calendar schedule provides finer control of resource allocation in a selected cluster node. In one embodiment, a calendar schedule utility may be included in WSRM 42 and/or 52. In general, the calendar schedule utility aids in applying a different resource policy to each cluster aware application at different points in time because of load variations. Other embodiments of utilities operable to designate and schedule application utilization of cluster node resources are contemplated within the spirit and scope of the teachings of the present disclosure.

Prior to implementation of the configured cluster aware application calendar schedules, a determination as to whether the cluster nodes selected for implementation of a selected cluster application can support both the application's calendar schedule as well as provide resource requirements for the cluster application. As such, at 82, a determination is preferably made as to whether the application schedule for a selected cluster aware application may be supported by its designated cluster node. In one embodiment, the determination made at 82 preferably includes consideration of information contained in a knowledge-base and associated with the cluster application resource requirements for the designated cluster configuration as well as platform characteristics of cluster nodes included in a designated cluster configuration.

At 82, if the resources of a cluster node platform are unable to support the calendar schedule and resource requirements of a respective cluster aware application, method 70 preferably proceeds to 84 where an error message indicating such an incompatibility is preferably generated. In addition to generating an error notice at 84, a request for an updated calendar schedule is preferably made at 86 before method 70 returns to 80 for an update or the creation of a calendar schedule for the cluster applications to be assigned to a selected node. Alternatively, if at 82 it is determined that the resources of a selected cluster node are sufficient to support both the calendar schedule and resource requirements of an assigned cluster application, method 70 preferably proceeds to 88.

Upon verification of the sufficiency of resources on a selected cluster node to support both the resource requirements and calendar schedule of a cluster application at 82, the designated calendar schedule for the selected cluster application is preferably implemented on its designated cluster node at 88. In one embodiment, capabilities preferably included in WSRM 42 and/or 52 include the ability to effect a calendar schedule for each cluster application to be included on a designated node of a particular information handling system cluster configuration. In general, implementation of a cluster application calendar schedule generally includes assigning resources and scheduling the cluster application for processing in accordance with its requirements and calendaring.

In one embodiment of method 70, a fail-over node for one or more of the cluster nodes preferably included in the information handling system cluster configuration is preferably designated at 90. In one embodiment, designation of a fail-over node may be based on an expected ability of a candidate fail-over node to assume processing responsibilities and application support for a failing-over application or applications. As such, designation of a fail-over node may include the designation of fail-over nodes most similar to their associated failing-over node. In an alternate embodiment, selection of similar nodes between failing-over and fail-over nodes may not be possible.

In addition to the designation of fail-over nodes at 90, method 70 may also provide for other proactive redundancy and availability measures. In one embodiment, at 92 method 70 may provide for the configuration of one or more anticipated fail-over events and the reservation of resources in response to such events. For example, based on experimentation and research, it may be known that certain cluster applications fail at a certain frequency or that certain platforms are known to fail after operating under certain working conditions. In the event such information is known, method 70 at 92 preferably includes for the planning of a response to such events.

At 94, the implemented calendar schedule for the cluster applications included on the nodes of the information handling system cluster configuration are preferably stored in a portion of shared data storage 16. In one embodiment, the calendar schedules for the one or more cluster applications are preferably included in knowledge-base 58. Further, such calendar schedules may be stored in dynamic data portion 62 of knowledge-base 58. Calendar schedules for the cluster applications are preferably stored in dynamic data area 62 as such calendar schedules may change in response to a fail-over event as well as in other circumstances. Additional detail regarding circumstances under which a calendar schedule for a selected cluster application may be changed will be discussed in greater detail below.

After completing an assignment of cluster applications to cluster nodes, designation of one or more fail-over nodes as well as the completion of other events, an application-to-node map is preferably generated and stored in knowledge-base 58 at 96. An application-to-node map may be used for a variety of purposes. For example, an application-to-node map may be used in the periodic review of a cluster configuration implementation to ensure that selected fail-over nodes in the application-to-node map remain the preferred node for their respective failing-over applications. Further, an application-to-node map generated in accordance with teachings of the present disclosure may be used to perform one or more operations associated with the reallocation of information handling system resources in response to a fail-over event. Following the generation and storage of an application-to-node map at 96, method 70 may end at 98.

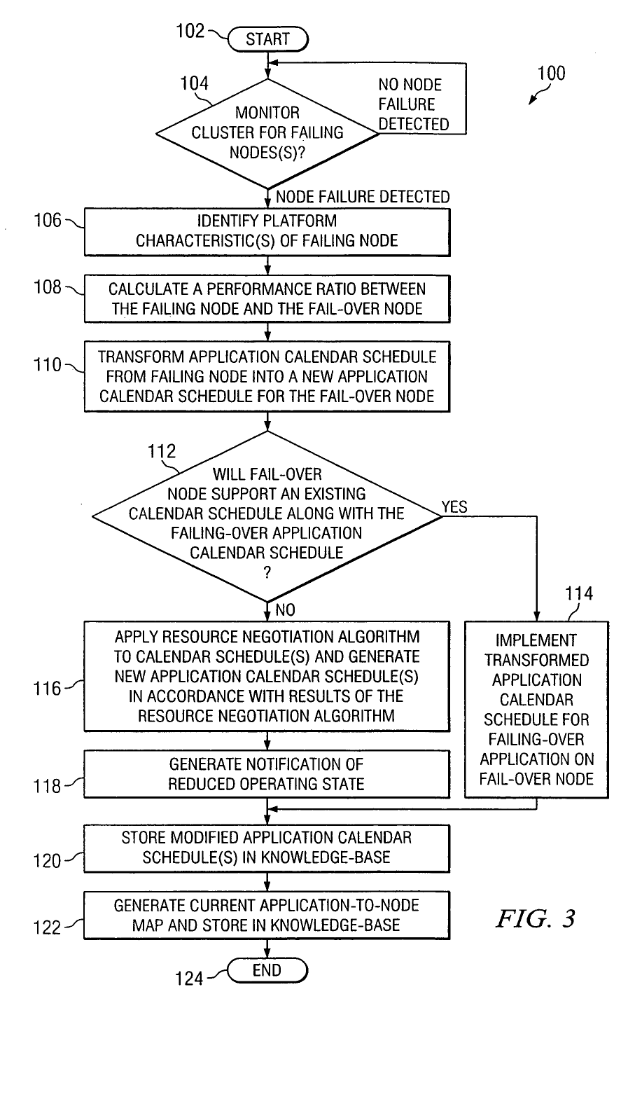

Referring now to FIG. 3, one embodiment of a method for reallocating information handling system cluster node resources in response to a fail-over event is shown generally at 100. According to teachings of the present disclosure, method 100 of FIG. 3 preferably enables the conversion of application resource requirements from one node platform in a heterogeneous cluster configuration into a usable set of resource requirements for a fail-over node platform of the heterogeneous cluster configuration. In one aspect, method 100 effectively minimizes or prevents cluster application starvation, memory thrashing and ensures fairness in accessibility to cluster node resources, as well as provides other advantages.

After beginning at 102, method 100 preferably proceeds to 104. At 104, one or more aspects of information handling system cluster configuration 10 may be monitored to determine the presence of a failed or failing node. If a failed node is not detected in the information handling system cluster configuration at 104, method 100 preferably loops and continues to monitor the cluster. Alternatively, if a node failure is detected at 104, method 100 preferably proceeds to 106.

At 106, one or more platform characteristics of the failed or failing node is preferably identified. In one embodiment, method 100 may access knowledge-base 58, static data portion 62 thereof in particular, to identify the platform characteristics concerning the cluster node of interest. Following the identification of one or more preferred platform characteristics of the failing or failed cluster node at 106, method 100 preferably proceeds to 108.

Using the platform characteristics of the failed or failing node identified at 106 and the same or similar characteristics concerning the designated fail-over node for the failing node obtained from knowledge-base 58, a performance ratio between the failing node and a fail-over node may be calculated at 108. In one aspect, the performance ratio calculated between the failing node and its designated fail-over node may include a performance ratio concerning the memories included on the respective cluster node platforms, the processing power available on the respective cluster node platforms, communication capabilities available on the respective cluster node platforms, as well as other application resource requirements.

When a node of a cluster configuration fails, it is generally known to the remaining nodes of the cluster configuration precisely which node is no longer in operation. By referring to the application-to-node map preferably included in knowledge-base 58, for example, the identity of a designated fail-over node for a failing node may be ascertained. Once the designated fail-over node for a failing node has been ascertained, one or more characteristics relating to information handling system resources of the fail-over platform may be ascertained from knowledge-base 58. In particular, static data portion 62 of knowledge-base 58, preferably included on shared data storage 16, may be accessed to identify one or more characteristics relating to the fail-over node platform. In addition, static data portion 62 of knowledge-base 58, preferably included on shared data storage device 16, may be accessed to ascertain desired characteristics of the now failed or failing node platform. Using the relevant data preferably included in knowledge-base 58, a performance ratio between the failing node and its designated fail-over node may be calculated at 108.

Having calculated a performance ratio between the failing node and the fail-over node at 108, method 100 preferably proceeds to 110. At 110, the application calendar schedule associated with the processing operations for each cluster application on the failing node prior to its failure is preferably transformed into a new application calendar schedule to be associated with processing operations for the failing-over cluster applications on the fail-over node. As mentioned above, cluster application calendar schedules for each node of an information handling system cluster configuration are preferably stored in knowledge-base 58. In particular, in one embodiment, the cluster application calendar schedules for each node of an information handling system cluster configuration are preferably included in dynamic data portion 60 of knowledge-base 58 preferably included on shared data storage device 16. Using the performance ratio between the failing node and fail-over node, the cluster application calendar schedule associated with the failed node and considering one or more aspects of the fail-over node, a modified or new cluster application calendar schedule for each of the failing-over applications from the failed or failing cluster node may be generated at 110. Additional aspects of an information handling system cluster configuration may be taken into account at 110 in the transformation of a calendar schedule associated with a cluster application from a failing node to a calendar schedule for the failing-over application on its designated fail-over node.

Following transformation of a calendar schedule associated with the failing-over cluster application to a new calendar schedule for the failing-over application on the fail-over node at 110, method 100 preferably provides for a verification or determination as to whether the designated fail-over node is capable of supporting its existing cluster application calendar schedules in addition to the transformed application calendar schedule associated with the one or more failing-over cluster applications. Accordingly, at 112, method 100 preferably provides for resolution of the query as to whether the designated fail-over node includes resources sufficient to support an existing calendar schedule along with any failing-over application calendar schedules.

If at 112 it is determined the information handling system resources associated with the designated fail-over node in the cluster configuration are sufficient to support execution and processing of an existing cluster application calendar schedule on the fail-over node as well as the execution and processing of transformed failing-over cluster application schedules, method 100 preferably proceeds to 114 where the transformed cluster application calendar schedule for the failing-over application on the fail-over node is preferably implemented. As mentioned above with respect to 88 of method 70, implementation of an application calendar schedule on a node may be effected through one or more utilities available on the fail-over cluster node including, but not limited to, WSRM 42 or 52.

If at 112 it is determined that the fail-over node does not include information handling system resources sufficient to support both the transformed cluster application calendar schedule for the failing-over application as well as the existing cluster application calendar schedule or schedules in existence on the designated fail-over node prior to the fail-over event, method 100 preferably proceeds to 114. At 114, a resource negotiation algorithm may be applied to one or more cluster application calendar schedule desired to be effected on the designated fail-over node.

In one embodiment, the resource negotiation algorithm applied at 114 may be applied only to the transformed cluster application calendar schedules associated with the failing-over cluster applications such that processing associated with the failing-over applications is reduced to the extent that the designated fail-over node can support both the cluster application calendar schedule resulting from application of the resource negotiation algorithm as well as its existing cluster application calendar schedule or schedules. In another embodiment, the resource negotiation algorithm to be applied to the cluster application calendar schedules at 114 may be uniformly applied across all application calendar schedules desired to be supported by the fail-over node such that the resource allocations for each application calendar schedule may be reduced to a point where the information handling resources available on the designated fail-over node are sufficient to appropriately effect the resource negotiation algorithm produced application calendar schedules. In such a case, resource reduction may come as a proportionate reduction across all cluster application calendar schedules to execute on a fail-over node. Alternative implementations of reducing information handling system resource requirements in response to a fail-over event and the subsequent reallocation of cluster applications to one or more fail-over nodes may be implemented without departing from the spirit and scope of teachings of the present disclosure.

Upon the application of a resource negotiation algorithm to one or more cluster application calendar schedules and the subsequent generation of one or more new cluster application calendar schedules at 116, method 100 preferably proceeds to 118. At 118, generation of a notification regarding a reduced operating state of one or more cluster aware applications and/or cluster nodes is preferably effected. In addition to generation of reduced operating state notification at 118, method 100 may also recommend repairs to a failed node, as well as the addition of one or more cluster nodes to the information handling system cluster configuration.

At 120, the modified or new cluster application calendar schedules resulting from either application of the resource negotiation algorithm at 116 or the cluster application calendar schedules transformations occurring at 110 are preferably stored. As mentioned above, calendar schedules associated with one or more cluster applications operating on one or more nodes of an information handling system cluster configuration are preferably stored in shared data storage device 16, in knowledge-base 58, preferably in dynamic data portion 60.

Following the storage of the new or modified application calendar schedules at 120, method 100 preferably proceeds to 122. At 122, similar to operations performed at 96 of method 70, a current application-to-node map is preferably generated and stored in knowledge-base 58. Method 100 then preferably ends at 124.

Although the disclosed embodiments have been described in detail, it should be understood that various changes, substitutions and alterations can be made to the embodiments without departing from their spirit and scope.

1. A method for allocating application processing operations among information handling system cluster resources in response to a fail-over event, comprising:
identifying a performance ratio between a failing-over cluster node and a fail-over cluster node;
transforming a first calendar schedule associated with failing-over application processing operations into a second calendar schedule to be associated with failing-over application processing operations on the fail-over cluster node in accordance with the performance ratio; and
implementing the second calendar schedule on the fail-over cluster node such that the fail-over cluster node may effect failing-over application processing operations according to the second calendar schedule.

2. The method of claim 1, further comprising determining whether resources on the fail-over cluster node are sufficient to support failing-over application processing operations in accordance with the second calendar schedule in addition to any existing fail-over cluster node application processing operations.

3. The method of claim 2, further comprising applying a resource negotiation algorithm to the application processing operations of the fail-over node in response to determining that the resources of the fail-over cluster node are insufficient to support both failing-over application processing operations in accordance with the second calendar schedule and any existing fail-over cluster node application processing operations.

4. The method of claim 3, further comprising:
calculating a new calendar schedule for the fail-over node application processing operations based on results from application of the resource negotiation algorithm; and
implementing the new calendar schedule on the fail-over node.

5. The method of claim 1, further comprising:
identifying at least one characteristic of the failing-over cluster node;
identifying at least one characteristic of the fail-over cluster node; and
calculating the performance ratio between the failing-over cluster node and the fail-over cluster node based on the identified characteristics of each node.

6. The method of claim 1, further comprising collecting information handling system cluster node resources required by at least one application to be deployed in an information handling system cluster configuration.

7. The method of claim 1, further comprising maintaining a knowledge-base containing information regarding one or more operational aspects of the information handling system cluster.

8. The method of claim 7, further comprising determining whether the first calendar schedule for a selected cluster node is feasible using operational aspects of the selected cluster node available in the knowledge-base.

9. The method of claim 1, further comprising updating an application-to-cluster node map identifying the cluster node associated with each application following the allocation of application processing operations among the information handling system resources in response to a fail-over event.

10. A system for maintaining resource availability in response to a fail-over event, comprising:
an information handling system cluster including a plurality of nodes;
at least one storage device operably coupled to the cluster; and
a program of instructions storable in a memory and executable in a processor of at least one node, the program of instructions operable to identify at least one characteristic of a failing node and at least one characteristic of a fail-over node, calculate a performance ratio between the failing node and the fail-over node, transform a processing schedule for at least one failing-over application to a new processing schedule associated with failing-over application processing on the fail-over node in accordance with the performance ratio and implement the new processing schedule for the failing-over application on the fail-over node.

11. The system of claim 10, further comprising the program of instructions operable to gather node resource requirements for at least one application to be deployed in the cluster.

12. The system of claim 11, further comprising the program of instructions operable to gather resources available on at least one node of the cluster.

13. The system of claim 12, further comprising the program of instructions operable to verify that the resources of a selected node are sufficient to perform processing operations in accordance with the resource requirements of at least one application to be deployed on the selected node.

14. The system of claim 10, further comprising the program of instructions operable to:
evaluate application processing resources available on the fail-over node; and
determine whether the application resources available on the fail-over node are sufficient to perform processing operations for the failing-over application in accordance with the new processing schedule and any existing fail-over application processing operations.

15. The system of claim 14, further comprising the program of instructions operable to
apply a resource negotiation algorithm to at least the new processing schedule in response to a determination that the application processing resources of the fail-over node are insufficient to support both the processing schedule of the failing-over application and any existing fail-over applications;
calculate at least one modified processing schedule in accordance with results of the resource negotiation algorithm; and
implement the modified processing schedule on the fail-over node.

16. The system of claim 15, further comprising the program of instructions operable to apply the resource negotiation algorithm to the new processing schedule for the failing-over application and at least one existing fail-over node processing schedule.

17. Software for allocating information handling system resources in a cluster in response to a fail-over event, the software embodied in computer readable media and when executed operable to:
access a knowledge-base containing application resource requirements and available cluster node resources;
calculate a performance ratio between a failing node and a fail-over node;
develop a new processing schedule for a failing-over application on the fail-over node in accordance with the performance ratio; and
queue the failing-over application for processing on the fail-over node in accordance with the new processing schedule.

18. The software of claim 17, further operable to:
gather resource requirements for each application in the cluster selected for fail-over protection; and
store the application resource requirements in a static data portion of the knowledge-base.

19. The software of claim 18, further operable to:
gather available resource information for each cluster node selected for operation as a fail-over node; and
store the available node resource information in the static data portion of the knowledge-base.

20. The software of claim 19 further operable to determine whether a selected node includes resources available to support a processing schedule for a selected application based on the resource requirements of the application and the available resources on the node from information maintained in the knowledge-base.

21. The software of claim 17, further operable to determine whether the new processing schedule may be supported by the fail-over node.

22. The software of claim 21, further operable to:
apply a resource negotiation algorithm to each processing schedule associated with the fail-over node;
generate new processing schedules for applications to be executed by the fail-over node; and
queue the applications to be executed by the fail-over node in accordance with resource negotiation algorithm generated processing schedules.

23. The software of claim 17, further operable to update an application-to-node map contained in the knowledge-base.
